(19) United States
(12) Patent Application Publication
(10) Pub. No.: US 2004/0040818 A1
(43) Pub. Date: Mar. 4, 2004

(54) Clutch driven plate

(76) Inventor: Alastair John Young, Kenilworth (GB)

Correspondence Address: Paul E Milliken, 9061 Wall Street NW, Massillon, OH, 44646-1676, US

(21) Appl. No.: 10/399,832

(22) PCT Filed: Aug. 16, 2002
(86) PCT No.: PCT/GB02/03786

(30) Foreign Application Priority Data
Aug. 24, 2001 (GB) 0120643.2

(51) Int. Cl. F16D 13/68

(52) U.S. Cl. 192/107 C

(57) ABSTRACT

A clutch driven plate (10) has a central hub member (11) with radially extending drive formations (19) which engage co-operating drive formations (23) on an outer annular disc member (12) carrying friction lining means (15a, 15b). The disc member has a radially inner peripheral portion (21) which is axially displaced relative to the remainder of the disc member and is connected thereto by an axially cranked portion (22) of the disc member, the cranked portion being provided with apertures/windows (23) which are engaged by the radially extending drive formations (19). Spring means (24, 25) carried by the disc member act to try to maintain the radially inner flange portion (21) in contact with one side of the radially extending drive formations (19) whilst allowing limited tipping of the disc member (12) and hence the friction lining means (15a, 15b) relative to the hub member (11) during use of the driven plate.

The present invention relates to driven plates for friction clutches and in particular to driven plates for friction clutches in motor vehicles.

Known driven plates for friction clutches comprise a central hub for connection with a shaft and an outer annular disc member carrying a friction lining means, the disc member being mounted concentrically about and drivingly connected to the hub. Such known driven plates are hereinafter referred to as driven plates of the type described.

Driven plates of the type described are often used in friction clutches for motor vehicles to selectively transfer drive from a flywheel, which may be attached to the crankshaft of an internal combustion engine, to a drive shaft of the vehicle transmission. Such known friction clutches typically comprise a clutch cover assembly attached to the flywheel with the driven plate located between the clutch cover assembly and the flywheel. The clutch cover assembly comprises a pressure plate which is biased axially towards the flywheel when the clutch is engaged to clamp the friction lining means of the driven plate between the pressure plate and the flywheel so that drive is transmitted from the flywheel to the driven plate and then via the hub to the transmission drive shaft.

It is known in driven plates of the type described for the outer annular disc member to be drivingly connected to the hub by means of inter-engaging drive formations which have limited radial and circumferential clearances to allow the disc member to move radially and circumferentially relative to the hub to a limited extent. Such driven plates may include a torsion damper to isolate the drive line from vibrations generated in the engine. It is also known for such driven plates to have a predamper or idle centre between the outer disc member and the central hub to isolate the drive line from low level vibrations which occur when the engine is idling or running at relatively low speed.

Alternatively driven plates of the type described may be of the rigid type in which no torsion damper is provided and the outer disc member is fixed rotationally fast with, or is integral with, the central hub. Such rigid driven plates are often used in conjunction with twin mass flywheels which comprise a torsion damper to isolate the drive line from vibrations generated by the engine.

Due to manufacturing tolerances et cetera, it is not always possible to ensure that when a vehicle engine and drive line are assembled the axes of the crankshaft and transmission drive shaft are in angular alignment. Where there is some angular misalignment between these axes then there will be a tendency for the friction lining means of the driven plate, which is clamped to the flywheel, to rotate about the axis of crankshaft or flywheel whilst the hub of the driven plate is constrained to rotate about the axis of the transmission drive shaft. Thus because the friction linings and the hub are rotating about separate non-angularly aligned axes, cyclical stresses are set up in the driven plate.

In addition, when the flywheel is attached to an internal combustion engine, the forces acting on the crankshaft of the engine may cause the flywheel to swash or whirl about the axis of the crankshaft. When the clutch is engaged the friction lining means of the driven plate will tend to follow the movement of the flywheel and so will swash or whirl about the hub which is constrained to rotate about the axis tranismission drive shaft. This again sets up cyclical stresses in the driven plate.

When cyclical stresses are set up in the driven plate, this can lead to fatigue failure in the material of the driven plate. This is a particular problem in driven plates of the rigid type in which the friction linings are mounted on relatively thin spring segments. In such cases most of the relative movement between the friction linings and the central hub is absorbed by the spring segments which are flexible compared to the rest of the driven plate. As a consequence the segments are subjected to cyclical stressing and in extreme cases the material in the segments may fail due to fatigue.

Problems can also arise in driven plates of the type described which have a pre-damper or idle centre. In this type of driven plate the relative movement between the friction lining means and the hub may be taken up in the pre-damper which as a result is no longer able to function correctly.

An object of the present invention is to provide an improved driven plate of the type described which overcomes or at least mitigates the problems of the known driven plate.

Thus according to the present invention there is provided a clutch driven plate comprising:—

A clutch driven plate comprising

a central hub member,

an outer annular disc member carrying friction lining means,

the hub member having radially extending drive formations which engage cooperating drive formations on the outer disc member,

the driven plate being characterised in that the disc member has a radially inner peripheral portion which is axially displaced relative to the remainder of the disc member and is connected thereto by an axially cranked portion of the disc member,

the cranked portion is provided with apertures/windows which are engaged by the radially extending drive formations, and

spring means are carried by the disc member acting to try to maintain the radially inner flange portion in contact with one side of the radially extending drive formations whilst allowing limited tipping of the disc member and hence the friction lining means relative to the hub member during use of the driven plate.

The spring means may comprise a disc-like spring member with radially inwardly extending spring fingers which bear against a side portion of the hub member to try to maintain said contact whilst allowing said tipping.

A gap may be provided between part of the spring fingers and an adjacent portion of the hub member which gap tends to close as the disc member tips relative to the hub so that the hub eventually contacts the spring fingers remote from their end portions to provide higher resistance to further tipping.

The radially extending drive formations may comprise teeth formed on the hub which engage apertures/windows in the cranked portion of the disc member.

In one embodiment of the invention the clearances between the radially extending drive formations and the apertures/windows are only normal sliding tolerances (i.e. typically 0.05 mm on each side or 0.1 mm total) so that only limited tipping of the flange member relative to the hub member is possible.

In an alternative embodiment the radially and circumferential clearances between the drive formations and apertures/windows are increased to give several degrees of angular movement, typical ±5°, and further spring means are provided to tend to centre the flange member relative to the hub member.

This further spring means may comprise a plurality of circumferentially spaced (circumferentially acting) compression springs acting between the hub and disc members.

The friction lining means may include axial cushioning. This cushioning may be provided by axially acting metal spring means (e.g. spring segments) acting between the disc member and friction lining means. Alternatively elastomeric means may be located between the disc member and the lining means to provide the axial cushioning. See, for example, the elastomeric cushion arrangements disclosed in the patents referred to later below.

One embodiment of the present invention will now be described, by way of example only, with reference to the accompanying drawings in which:—

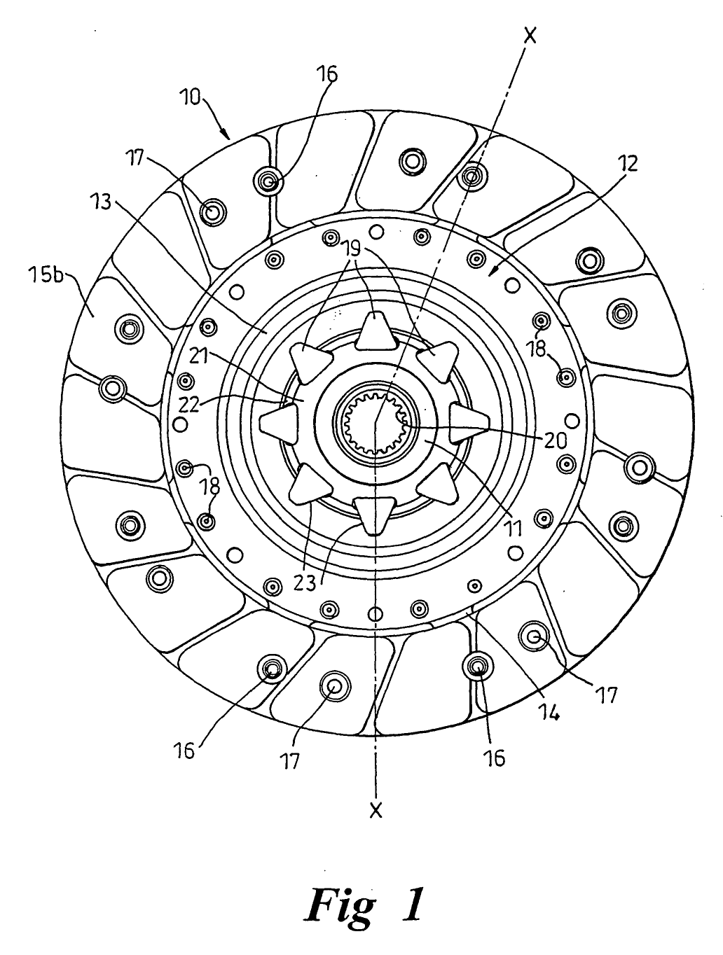

FIG. 1 shows a side view of a driven plate in accordance with the present invention;

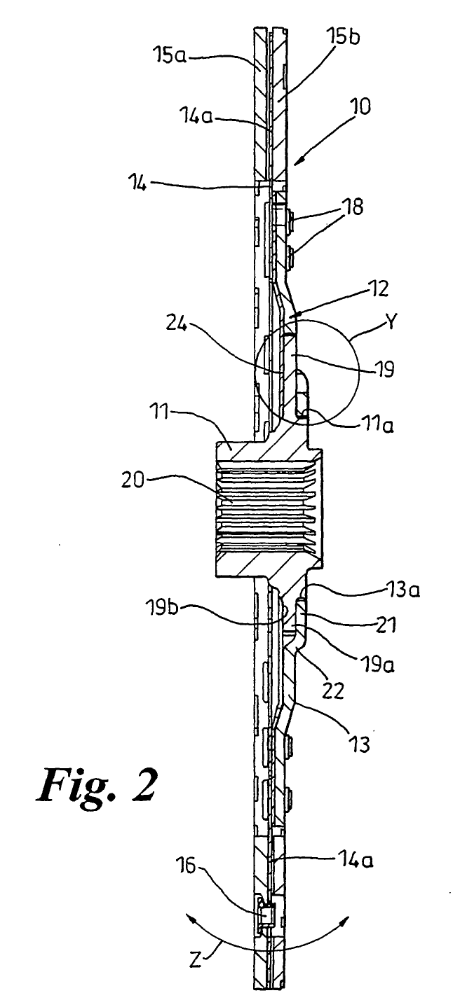

FIG. 2 shows an enlarged radial section on the line X-X of FIG. 1;

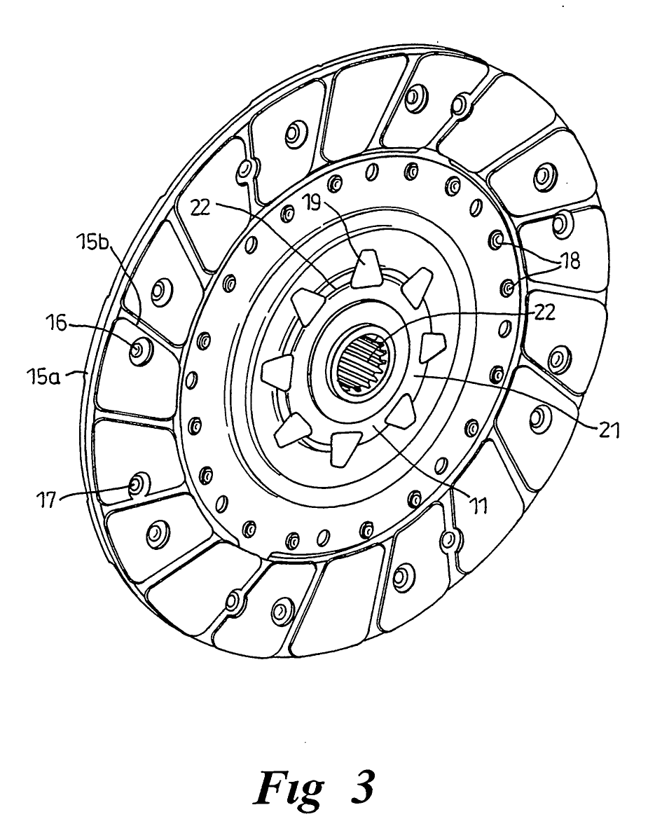

FIG. 3 shows a perspective view of the driven plate of FIG. 1;

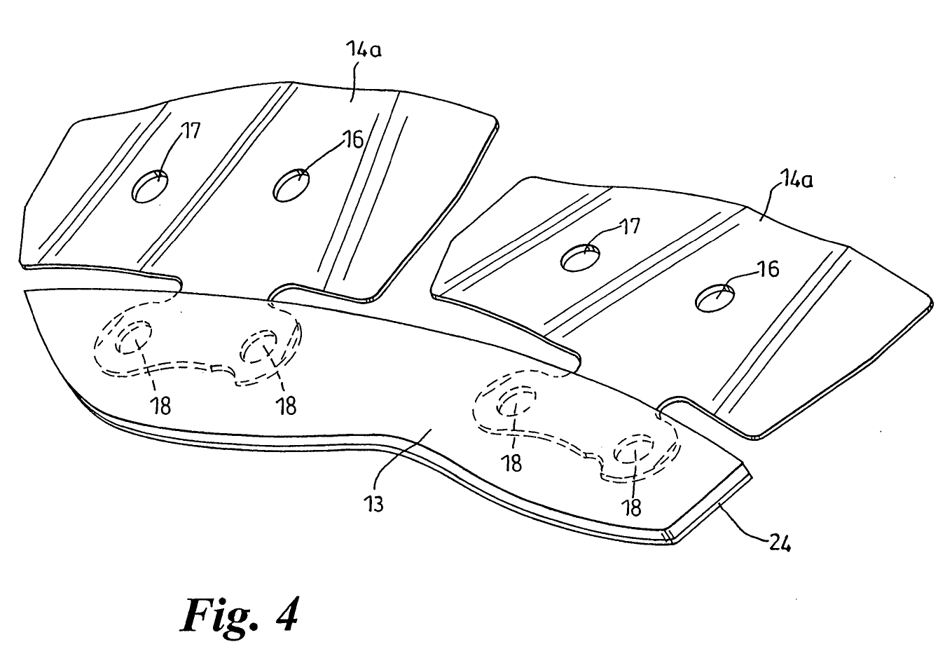

FIG. 4 shows a perspective view of part of a spring segment friction lining mounting arrangement used in the driven plate of FIG. 1;

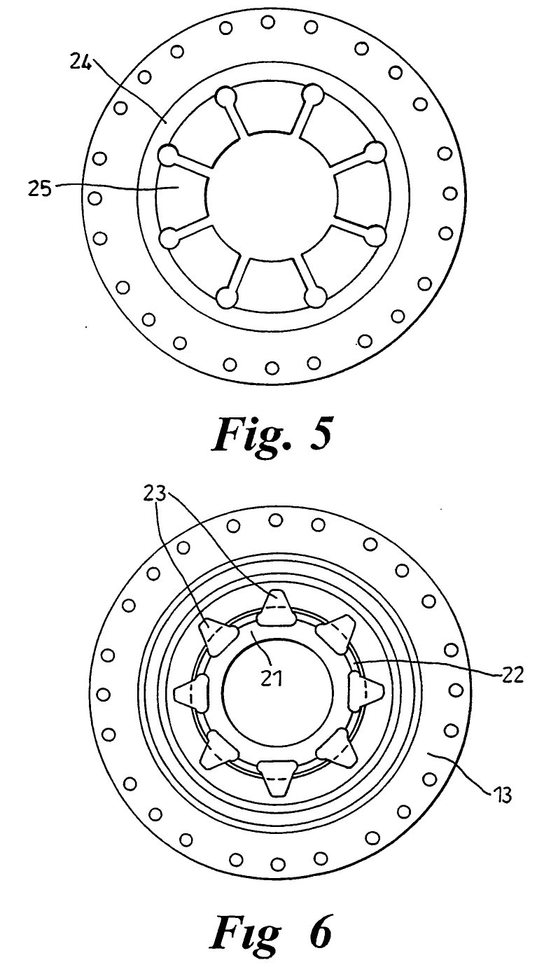

FIG. 5 shows a side view of a disc-like spring member used in the driven plate of FIG. 1;

FIG. 6 shows a side view of part of an inner portion of an outer annular disc member used in the driven plate of FIG. 1;

FIG. 7 shows a side view of a hub member used in the driven plate of FIG. 1;

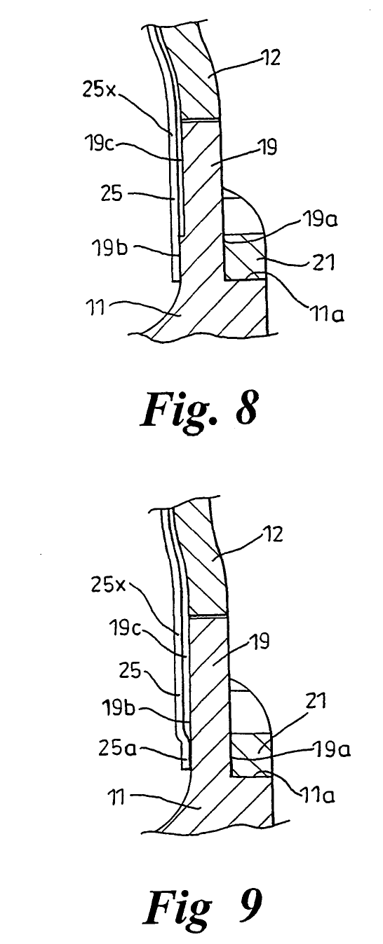

FIG. 8 shows an enlarged view of the portion of FIG. 2 circled at Y;

FIG. 9 shows an alternative construction to that shown in FIG. 8;

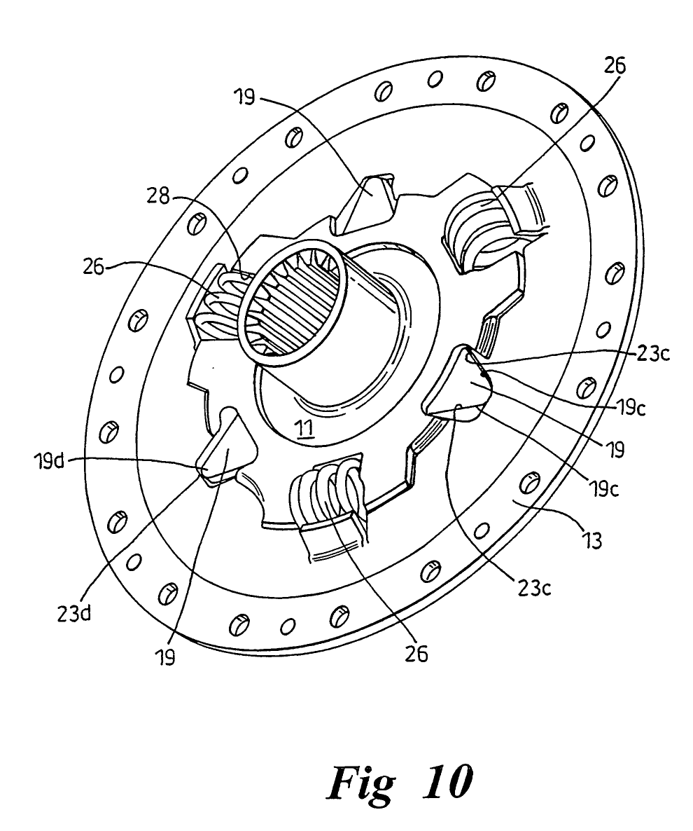

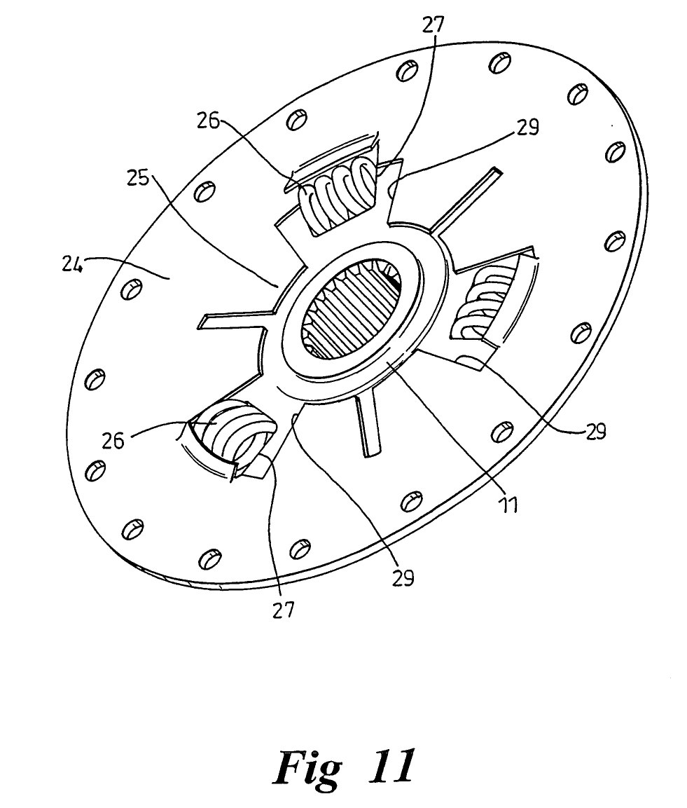

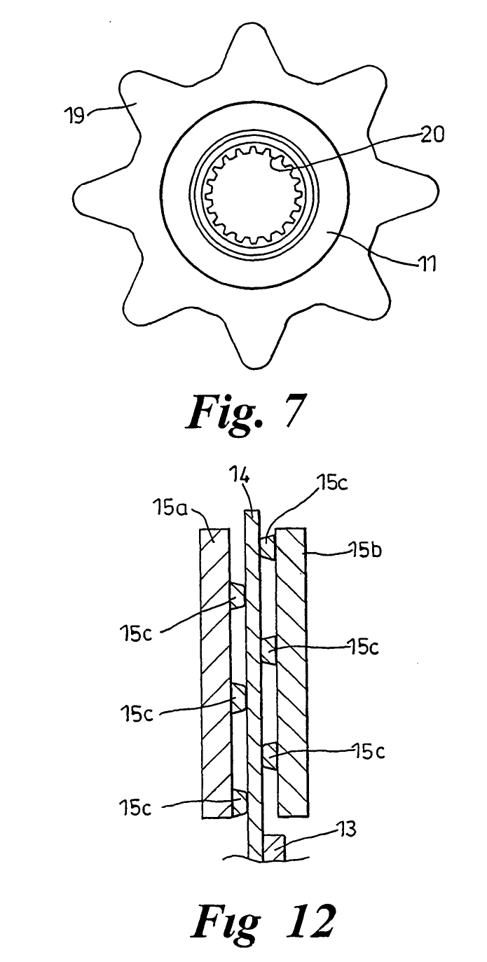

FIGS. 10 and 11 show perspective views of an alternative form of driven plate in accordance with the present invention which includes circumferentially acting compression springs, and

FIG. 12 shows an alternative friction lining attachment arrangement for use in the driven plate of FIG. 1.

Referring to FIGS. 1 to 7 the driven plate 10 comprises a central hub 11 and an outer annular disc member 12 which comprises a radially inner portion 13 and a radially outer portion 14 in the form of circumferential spaced spring metal segments 14a (see FIG. 4) Segments 14a carry annular friction linings 15a and 15b on opposite sides thereof. These linings are riveted to opposite sides of the segments 14a by two series of rivets 16 and 17 respectively. The spring segments 14a of disc member 12 is riveted to the inner portion 13 by a further series of rivets 18 and provide axial cushioning of the linings in the known manner.

In accordance with the invention the hub 11 has a series of radially extending drive formations in the form of teeth 19 (see FIG. 7) and inner splines 20 for engagement with an associated transmission drive shaft (not shown).

The inner portion 13 of disc member 12 (see FIG. 6) has an inner peripheral portion 21 which is displaced axially relative to the remainder of the inner portion 13 by an axially cranked portion 22. The cranked portion 22 is itself provided with apertures/windows 23 into which the radially extending teeth 19 extend. The clearances between the teeth 19 and the apertures 23 are normal engineering sliding clearances (i.e. typically 0.05 mm on each side or 0.1 mm total)

The inner peripheral portion 21 of the disc member 12 is held in contact with the right hand face 19a of the hub member by a disc-like spring member 24 shown in detail in FIG. 5. This spring member is riveted to the inner portion 13 of disc member 12 by the same rivets 18 as the outer disc portion 14 and has radially inwardly projecting spring fingers 25 which bear against the stepped left hand side 19b of hub member 11 to maintain the inner peripheral portion 21 of inner disc portion 13 in contact with the right hand face 19a of the hub. This is shown on a larger scale in FIG. 8 where the gap 19c between the spring fingers 25 and the outer portion of teeth 19 caused by the step 19b can be seen.

As will be appreciated, the annular disc member 12 can tilt as shown by the arrow Z in FIG. 2 relative to the hub portion 11 as a result of the flexing of disc-like member 14 which tends to return the disc member 12 to the centralised position shown in FIG. 2. When the tilting of disc-like member 14 exceeds a predetermined angle gap 19c is closed and teeth 19 contact fingers 25 in the region 25x thereof (see FIG. 8) so that further resistance to tilting is applied.

Thus the driven plate can accommodate mis-alignment between the axis of rotation of an associated flywheel (not shown) against which the friction linings 15a and 15b are clamped when the clutch is engaged and the associated transmission drive shaft (also not shown) which engages splines 20.

FIG. 9 shows an alternative form of fingers 25 in which the gap 19c is provided without stepping the left hand side 19b of fingers 19 by bending the radially inner portions 25a of fingers 25 to the right as viewed in FIG. 9.

This simplifies the manufacture of hub 11 which can be still further simplified and made more economical by other measures such as fabricating the radially extending fingers 10 on a separate component from the inner sleeve portion of the hub.

FIGS. 10 and 11 show a view of an alternative form of the inner portion 13 of the driven plate in which a fewer number of radially extending teeth 19 and co-operating apertures 23 are provided and the circumferential clearance between the flanks 19c of the teeth 19 and the sides 23c of the apertures 23 and the radial clearance between the tips 19d of teeth 19 and the outer edges 23d of the apertures 23 are significantly greater. These increased clearances allow the hub 11 to move circumferentially by typically 5° in each direction. This freedom of movement also allows the hub 11 to move radially relative to the inner disc member portion 13. This radial movement would be limited by the clearance between the bore 13a of inner portion 13 and the diameter of the step 11a on hub 11 which is typically 0.5 to 1 mm. This movement between teeth 19 and apertures 23 is resisted by circumferentially extending and acting compression springs 26 which act in pockets 27 in the hub 11 and windows 28 in the inner portion 13 of the disc member 12. Typically the springs 26 allow this ±5° travel to be taken-up at a relatively low proportion of the maximum engine torque (typically 10°-30%, say 20%) depending on the application so that the driven plate effectively becomes solid at low engine torques. The rate of springs 26 and any pre-load thereon must also be designed to ensure that the disc portion 13 cannot be centrifuged off-centre at normal ruling speeds.

As can be seen from FIG. 11, some of the fingers 25 of the disc-like spring member 24 are cut away at 29 to allow the hub 11 to move circumferentially relative to disc member 13 without contacting springs 26. The larger clearances provided between the teeth 19 and apertures 23 allows the disc member 12 to not only cater for angular misalignment of the flywheel and transmission input shaft but also to cater for a degree of radial misalignment so that the driven plate is not only self-aligning but self-centring under the action of the compression springs 26.

Although in the arrangements described above the friction linings 15a and 15b have been secured on either side of the spring segments 14a of the disc member 12 by rivets 16 and 17, it will be appreciated that the friction linings 15a and 15b may be bonded to an annular outer portion 14 of the disc member 12 using elastomeric cushioning beads of adhesive 15c as shown in FIG. 12 and as described in, for example, patents EP0252583, EP0390797, EP0323036, EP0455694, EP0510014, EP 0442539, EP 0638149, GB2247725, GB2243419 and GB2272494. In a still further alternative arrangement the friction linings 5a and 15b may be rigidly secured to a rigid outer portion 14 of disc member 12 to provide a driven plate without axially cushioned linings.

1) a clutch driven plate comprising
a central hub member,
an outer annular disc member carrying friction lining means,
the hub member having radially extending drive formations which engage cooperating drive formations on the outer disc member,
the driven plate being characterised in that the disc member has a radially inner peripheral portion which is axially displaced relative to the remainder of the disc member and is connected thereto by an axially cranked portion of the disc member,
the cranked portion is provided with apertures/windows which are engaged by the radially extending drive formations, and
spring means are carried by the disc member acting to try to maintain the radially inner flange portion in contact with one side of the radially extending drive formations whilst allowing limited tipping of the disc member and hence the friction lining means relative to the hub member during use of the driven plate:

2) A driven plate according to claim 1 characterised in that the spring means comprises a disc-like spring member with radially inwardly extending spring fingers which bear against a side portion of the hub member to try to maintain said contact whilst allowing said tipping.

3) A driven plate according to claim 2 characterised in that a gap is provided between part of the spring fingers and an adjacent portion of the hub member which gap tends to close as the disc member tips relative to the hub so that the hub eventually contacts the spring fingers remote from their end portions to provide higher resistance to further tipping.

4) A driven plate according to claims 2 or 3 characterised in that the radially extending drive formation comprise teeth formed on the hub which engage apertures/windows in the cranked portion of the disc member.

5) A driven plate according to any one of claims 1 to 4 characterised in that the clearances between the radially extending drive formations and the apertures/windows are normal sliding tolerances so that only limited tipping of the flange member relative to the hub member is possible.

6) A driven plate according to any one of claims 21 to 4 characterised in that the radially and circumferential clearances between the drive formations and apertures/windows are increased to give several degrees of angular movement and further spring means are provided to tend to centre the disc member relative to the hub member.

7) A driven plate according to claim 6 characterised in that the further spring means comprises a plurality of circumferentially spaced compression springs acting between the hub member and the disc member.

8) A driven plate according to any one of claims 1 to 7 characterised in that that friction lining means includes axial cushioning.

9) A driven plate according to claim 8 characterised in that the axial cushioning is provided by axially acting metal springs acting between the disc member and the friction lining means.

10) A driven plate according to claim 9 characterised in that the axial cushioning is provided by elastomeric cushion means acting between the disc member and the friction lining means.

11) A clutch driven plate constructed and arranged substantially as hereinbefore described with reference to and as described in FIGS. 1 to 7 or 8 or 9 or 10 and 11 or 12 of the accompanying drawings.
